(19) United States
(12) Patent Application Publication
(10) Pub. No.: US 2006/0086013 A1
(43) Pub. Date: Apr. 27, 2006

(54) In-mold chip

(75) Inventors: Jeffrey J. Stegman, Cincinnati, OH (US); Todd R. Stegman, Cincinnati, OH (US)

Correspondence Address: GRAYDON HEAD AND RITCHEY LLP, 1900 FIFTH THIRD CENTER, 511 WALNUT STREET, CINCINNATI, OH, 45202, US

(73) Assignee: The Osbome Coinage Company

(21) Appl. No.: 11/120,697

(22) Filed: May 3, 2005

Related U.S. Application Data
(60) Provisional application No. 60/616,338, filed on Oct. 5, 2004.

(51) Int. Cl. G09F 3/02

(52) U.S. Cl. 40/27.5

(57) ABSTRACT

An in-mold chip is provided that includes first and second labels, printed visible indicia, a protective coating and a thermoplastic polymer. The first and second labels are disposed adjacent each other about a common central axis, each label having a first surface and a second surface. The printed visible indicia is selectively applied to one or more portions of at least one of the first and second surfaces of the first and second labels. The protective coating is selectively applied to the surface of the first and second labels containing the printed visible indicia. The first and second labels are encased by the thermoplastic polymer during the in-mold process. A method for making an in-mold chip is also provided.

### CROSS REFERENCE TO RELATED APPLICATIONS

The present application claims the benefit of U.S. Provisional Patent Application Nos. 60/567,372, filed Apr. 30, 2004 and 60/616,338 filed Oct. 5, 2004.

### FIELD OF THE INVENTION

The present invention relates, in general, to chips, tokens or medals and the method for making these chips, tokens or medals. More particularly, the invention is directed to chips, tokens or medals manufactured by in-mold decorating (IMD)/in-mold labeling (IML) and having improved quality, security and durability.

### BACKGROUND

In general, gaming chips are manufactured from rigid plastic. In addition, gaming chips or tokens are subjected to decoration by marking their faces and/or edges and which, depending on the eventual uses of the chips, can range from the simplest to the most complex. More precisely, the decoration of the chips is capable of fulfilling at least one of many functions including: i) a function of identification of the casino and/or the gambling table and/or the player; ii) a function of identification of the value represented by the chip; iii) a function of decoration having an aesthetic character and/or of an advertising medium; and iv) a function of security against the risk of fraudulent manufacture and/or reproduction.

Among surface marking techniques for gambling chips, laser etching, applique (inlay), aquagraphics and pad printing are known. In laser etching, continuous layers of ink are deposited onto a substrate, and then cut back by high power laser to reveal the required colors. This method produces very good results, but is slow and not recommended for high-volume applications. The inlay process takes place when a printed, self-adhesive label is applied to a substrate. This method commonly relies on the screen-printing process and is inexpensive and easy to produce, but the label can be peeled and tends not to look like an integral part of the molding.

In aquagraphics, the image is printed onto a water-soluble film. The film is then floated on water until it dissolves, after which a substrate is brought up through the water and into contact with the remaining graphic image. The woodgrain effects produced with this method are impressive, but post-treatment with a protective spray is essential. This method's costs are generally high. Pressure pad printing, sublimation printing or marking is also used to decorate gaming chips.

It is also known in the prior art to use gaming chips as part of a tracking system for the purpose of ascertaining the gambling habits of an individual gambler. Such information allows a casino to rate players' betting activities in order to identify players that the casino wants to encourage to gamble in the casino, and to provide them with a commensurate level of free services, meals and merchandise such as accommodations, transportation, entertainment, food and beverages, known as “comping”.

Comping is widely used by casinos to attract and hold gamblers. For example, Atlantic City and Nevada casinos comp players in the amount of hundreds of millions of dollars each year. However, even though casinos have attempted to track table player betting accurately, for example, by pit boss observation, a substantial portion of the comping inevitably goes to undeserving players while some deserving players go uncomped.

As a result of the foregoing, there exists a need for a new method of manufacturing and marking gaming chips which eliminates or substantially reduces the limitations and other drawbacks of the methods presented above. In addition, the final decoration of the chip must in general exhibit good wear resistance in order to take into account the often harsh conditions under which a gaming chip is used, due especially to the frequent handling of casino chips on the gambling tables or during operations of counting, sorting or washing the chips.

### SUMMARY

In accordance with one embodiment of the present invention there is provided an in-mold chip. The in-mold chip includes first and second labels, printed visible indicia, a protective coating and a thermoplastic polymer. The first and second labels are disposed adjacent each other about a common central axis, each label having a first surface and a second surface. The printed visible indicia is selectively applied to one or more portions of at least one of the first and second surfaces of the first and second labels. The protective coating is selectively applied to the surface of the first and second labels containing the printed visible indicia. The first and second labels are encased by the thermoplastic polymer during the in-mold process.

In accordance with another embodiment of the present invention, a method of preparing an in-mold chip is provided. The method includes the steps of providing first and second labels, each label having a first surface and a second surface; applying printed indicia to one or more portions of at least one of the first and second surfaces of the first and second labels; applying a protective coating to the surface of the first and second labels containing the printed visible indicia; cutting the first and second labels to size; providing an injection mold having cavities moveable between an open and closed position; positioning the first and second labels in the mold cavities and closing the mold; and injecting a thermoplastic polymer into the mold to encase the first and second labels.

Also provided is a system for tracking information from in-mold gaming chips. The system includes a plurality of in-mold chips and a plurality of means for reading and processing the covert marking information represented on the plurality of in-mold chips. The plurality of in-mold chips include first and second labels, printed visible indicia, printed covert marks, a protective coating and a thermoplastic polymer. The first and second labels are disposed adjacent each other about a common central axis, each label having a first surface and a second surface. The printed visible indicia and printed covert marks are selectively applied to one or more portions of at least one of the first and second surfaces of the first and second labels, while the protective coating is selectively applied to the surface of the first and second labels containing the printed visible indicia. The first and second labels are encased by the thermoplastic polymer during the in-mold process.

Still other embodiments, examples, features, aspects, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description taken in conjunction with the accompanying drawings, in which like reference numerals identify the same elements and in which:

FIG. 1 illustrates an example of an in-mold chip in accordance with the present invention.

FIG. 2 illustrates an example of an exploded view of the in-mold chip of FIG. 1, absent the molded outer shell.

FIG. 3 illustrates an example of a magnified view of the surface marks of FIG. 1 in accordance with the present invention.

FIG. 4 illustrates an example of covert marks in accordance with the present invention.

### DETAILED DESCRIPTION

Reference will now be made in detail to various embodiments of the present invention, examples of which are illustrated in the accompanying drawings wherein like numerals indicate the corresponding structure throughout the views. As will be understood hereafter, the disclosed embodiments are merely exemplary of the invention, which may be embodied in various forms. Therefore, specific structural and functional details disclosed herein are not to be interpreted as limiting, but merely a basis for the claims and as a representative basis for teaching one skilled in the art to variously employ the present invention in virtually any appropriately detailed structure.

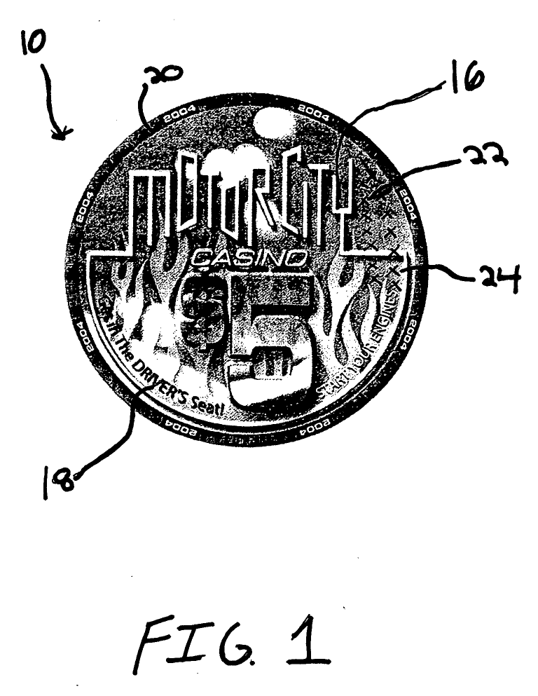

Referring initially to FIG. 1, there is shown an example of an in-mold chip 10 in accordance with one embodiment of the present invention. In the present example, the chip 10 is a gaming chip or gaming token for commercial use by casinos or at-home use by individuals. In other embodiments, chip 10 can be a medal, for example, an award for winning a championship or commemorating some other event.

In the present example, chip 10 includes a first label 12 and a second label 14, printed visible indicia 16 and 18, a protective coating and a thermoplastic polymer. First and second labels 12 and 14 are disposed adjacent each other about a common axis, each label having a first surface and a second surface. Labels 12 and 14 can be microporous or non-microporous. Examples of suitable materials for labels 12 and 14 are available from PPG Industries of Pittsburgh, Pa., sold under the name TESLIN and Avery Denison of Pasadena, Calif., sold under the name ACCU-PLACE. Typically, labels 12 and 14 have a thickness of from about 7 mil to about 10 mil. Any suitable shape can be used for labels 12 and 14. For example, while a generally circular shape is preferred, labels of other shapes, such as oval, rectangular, triangular, square or other shape may be used, if desired.

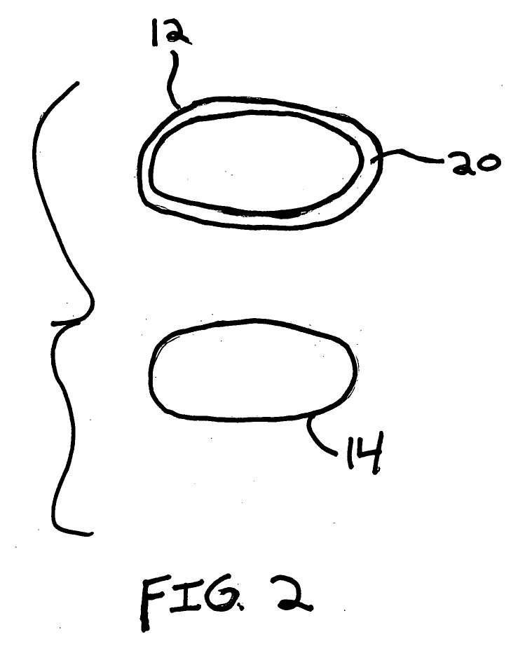

As best seen in the example shown in FIG. 2, first label 12 has a circumference greater than the circumference of second label 14. This allows first label 12 to cover one side/face of chip 10 and also cover edge 20 of chip 10, while second label 14 covers the opposite side/face of chip 10. In other examples, labels 12 and 14 are the same size. Typically, edge 20 includes cut-outs that assist in forming chip 10 by preventing wrinkles in first label 12. Printed visible indicia 16 and 18 of the exemplary chip 10 are created by applying ink to the labels 12 and 14 by methods known in the art, such as lithography, screen printing, flexography, ink-jet, laser, or any other method suitable for creating the desired indicia 16 and 18. These printing processes produce much higher resolution indicia than the current gaming chips on the market and thus provide an anti-counterfeit feature.

The information to be conveyed may take many forms, for example it may consist of letters, numbers, icons, logos, photos, artwork, graphics or other pictorial material or any combination of these, collectively known as printed visible indicia. In the example shown in FIG. 2, the printed visible indicia 16 and 18 is represented by, inter alia, the words “MOTOR CITY” and the phrase “Get In The Driver's Seat!”, respectively.

Labels 12 and 14 of chip 10 are also covered with protective coating. Such a coating results in a surface protection that is not present or is superior to pad printed gaming chips, even chips with varnish coatings which are easily scratched off. The protective coating also allows cleaning of chip 10 without degradation. The protective coating is applied to the surface of the labels containing printed visible indicia 16 and 18 by methods known in the art, such as screen printing, pad printing, roll coating, laminating, or any other method suitable for creating the desired coating. Examples of suitable protective coatings include, but are not limited to, acrylic, polyurethane, silicone or laminates, such as vinyl, polycarbonate, acrylic or polyethylene terephthalate (PET). Typically, the protective coating has a thickness of from about 1 mil to about 3 mil.

Chip 10 also includes a thermoplastic polymer for encasing labels 12 and 14 during the in-mold process. In one example, the thermoplastic polymer is a filled or unfilled resin. Examples of other suitable polymer materials include, but are not limited to, nylon, PVT, polycarbonate or ABS. Typically, the filler material is minerals, glass fibers or synthetic fibers.

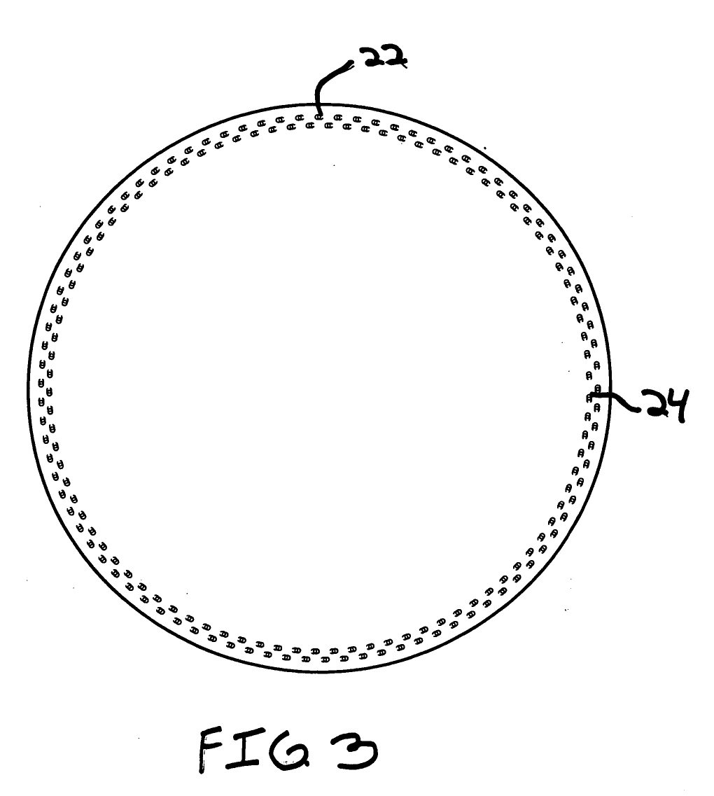

As shown in FIG. 3, the present invention may also include optional surface marks 22 and 24. Markings can be designed into the surface of the injection molding cavities so that during the in-mold process, surface marks 22 and 24 are applied to discrete portions of at least one of the surfaces of labels 12 and 14 containing the printed visible indicia 16 and 18 in order to create distinct portions on labels 12 and 14 for tactile feel. In the example shown in FIG. 3, surface marks 22 and 24 are recessed. In other embodiments, surface marks 22 and 24 may be raised. As further shown in FIG. 3, surface marks 22 and 24 will also provide a means of authenticating chip 10 and can include, for example, words, letters, numbers or other identifying symbols and features. In one example, the chip has a grid pattern of interlocked “OC”s across the face of both sides of chip 10. There are about 450 of these “OC”s per side and each “OC” is about 0.005″ across. Combined with the high resolution printing, the surface marks create a very secure, difficult to counterfeit chip. The pattern of multiple surface marks can be readily felt by the fingers of a dealer or cashier. In addition, the actual pattern of the surface marks can be viewed with a magnifying device such as a microscope.

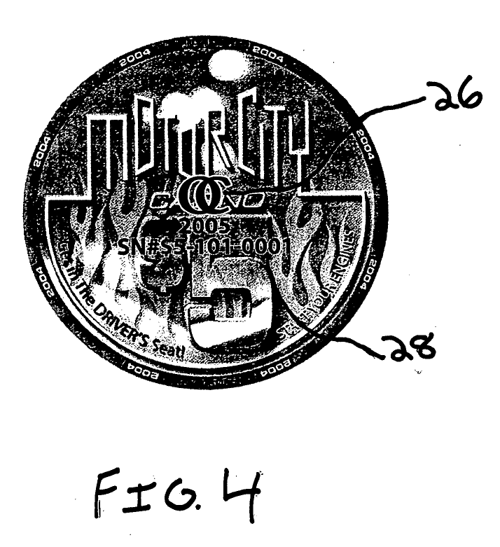

As further shown in FIG. 4, the present invention may also include optional covert marks 26 and 28. Covert marks 26 and 28 are applied to discrete portions of at least one of the surfaces of labels 12 and 14 containing printed visible indicia 16 and 18 by methods known in the art, such as lithography, screen printing, flexography, ink-jet, laser, or any other method suitable for creating the desired marking. In the example shown in FIG. 3, covert marks 26 and 28 are visible. In other embodiments, covert marks 26 and 28 may be non-visible, for example, the marks may comprise luminescent ink such that the marks are only visible with the aid of a ultraviolet or infrared source. Covert marks 26 and 28 will also provide a means of authenticating chip 10 and can include, for example, words, letters, numbers or other identifying symbols and features. The covert marks can make a unique code for each casino property, each denomination and even each individual chip if desired.

According to another embodiment of the present invention, chip 10 may also include an RFID chip and antenna. The RFID chip is affixed to the surface of first label 12 or second label 14 that is opposite the surface containing the printed visible indicia, by methods known in the art, such as manual placement or the use of a pick and place robot, other types of mechanical or robotic methods, or using a high speed process during the printing of the substrate. The antenna can be obtained as part of the RFID chip from an outside vendor or as another improvement the antenna could be printed onto the surface of the label using a standard printing process and appropriate conductive inks. This would allow flexibility in the size of the antenna and thus the strength of the RF signal. This is important to avoid cross-reading between players and tables for play tracking systems. The RFID chip would then be placed onto the antenna with conductive glues using various manufacturing methods such as those mentioned above.

In one example, the method for making chip 10 in accordance with the present invention is generally as follows. First, suitable first and second labels 12 and 14, as described above, are provided. Printed visible indicia 16 and 18 is then applied to one or more portions of at least one of the first and second surfaces of first and second labels 12 and 14. A protective coating is then applied to the surface of first and second labels 12 and 14 containing the printed visible indicia. After the protective coating is applied, first and second labels 12 and 14 are cut into the desired shape as described above, by methods known in the art, such as die-cutting, trimming or any other method suitable for creating the desired shape. A suitable injection mold having cavities moveable between an open and closed position is then provided. Thereafter, first and second labels 12 and 14 are positioned in the mold cavities. Labels 12 and 14 are held in the desired location in the mold by vacuum, by electrostatics or by the use of labels having adhesive properties. After positioning the label in the mold cavity, the mold is closed and a suitable thermoplastic polymer, as described above, is injected into the mold cavity. After the injection process, chip 10 is cooled and ejected from the mold.

In another example, during the method for preparing chip 10, microporous labels 12 and 14 are provided such that the thermoplastic polymer forms a mechanical bond with labels 12 and 14.

A system for tracking information from chip 10 includes a plurality of in-mold chips according to the present invention and a plurality of means for reading and processing covert marking information represented by covert marks 26 and 28. If a unique covert mark, such as a serial number, is provided with each individual chip, then the chips can be utilized by a tracking system. The casino would then know the fate of each chip, how many were cashed in at the end of play and how many were gambled and lost and at what table. The system would include chip readers throughout the casino, for example, at the cashier and at the tables where chips are bought and gambled. Examples of suitable tracking systems are available from Mikohn Gaming Corporation, sold under the name TABLELINK and Bally Systems, sold under the name MP21.

Having shown and described various embodiments of the present invention, further adaptations of the in-mold chip and method of making the same described herein can be accomplished by appropriate modifications by one of ordinary skill in the art without departing from the scope of the present invention. Several of such potential modifications have been mentioned, and others will be apparent to those skilled in the art. Accordingly, the scope of the present invention should be considered in terms of the following claims and is understood not to be limited to the details of structure and operation shown and described in the specification and drawings.

What is claimed is:

1. An in-mold chip, comprising:
first and second labels disposed adjacent each other about a common central axis, each label having a first surface and a second surface;
printed visible indicia selectively applied to one or more portions of at least one of the first and second surfaces of the first and second labels;
a protective coating selectively applied to the surface of the first and second labels containing the printed visible indicia; and
a thermoplastic polymer for encasing the first and second labels during the in-mold process.

2. The chip as defined by claim 1, wherein the first and second labels comprise a generally circular-shaped conformation.

3. The chip as defined by claim 2, wherein the circumference of the first label is greater than the circumference of the second label such that the first label covers a first side and edge of the chip and the second label covers a side opposite the first side.

4. The chip as defined by claim 1, wherein the protective coating comprises acrylic, polyurethane, silicone or laminate.

5. The chip as defined by claim 4, wherein the laminate is selected from the group consisting of polyethylene terephthalate, polycarbonate and acrylic.

6. The chip as defined by claim 1, further comprising surface marks selectively applied to discrete portions of at least one of the surfaces of the first and second labels containing the printed visible indicia to create distinct portions on the labels for tactile feel.

7. The chip as defined by claim 6, wherein the surface marks are raised or recessed.

8. The chip as defined by claim 1, wherein the first and second labels further comprise covert marks selectively applied to discrete portions of at least one of the surfaces of the first and second labels containing the printed visible indicia.

9. The chip as defined by claim 8, wherein the covert marks are visible or non-visible.

10. The chip as defined by claim 8, wherein the covert marks comprise luminescent ink.

11. The chip as defined by claim 1, further comprising a RFID chip affixed to the surface of the first or second label that is opposite the surface containing the printed visible indicia.

12. The chip as defined by claim 1, wherein the first and second label each have a thickness of from about 7 mil to about 10 mil.

13. The chip as defined by claim 4, wherein the protective coating has a thickness of from about 1 mil to about 3 mil.

14. A method for preparing an in-mold chip, comprising the steps of:
providing first and second labels, each label having a first surface and a second surface;
applying printed indicia to one or more portions of at least one of the first and second surfaces of the first and second labels;
applying a protective coating to the surface of the first and second labels containing the printed visible indicia;
cutting the first and second labels to size;
providing an injection mold having cavities moveable between an open and closed position;
positioning the first and second labels in the mold cavities and closing the mold; and
injecting a thermoplastic polymer into the mold to encase the first and second labels.

15. The method according to claim 14, wherein the printed indicia is created using lithography, screen printing, flexography, ink-jet printing or laser printing.

16. The method according to claim 14, further comprising:
applying surface marks to discrete portions of at least one of the first and second surfaces of the first and second labels to create distinct portions on the labels for tactile feel.

17. The method according to claim 14, wherein prior to the step of applying a protective coating, covert marks are printed on discrete portions of at least one of the first and second surfaces of the first and second labels.

18. The method according to claim 14, further comprising:
affixing a RFID chip to the first or second label.

19. A system for tracking information from in-mold gaming chips, comprising:
a plurality of in-mold chips, wherein the in-mold chip further comprises first and second labels disposed adjacent each other about a common central axis, each label having a first surface and a second surface; printed visible indicia selectively applied to one or more portions of at least one of the first and second surfaces of the first and second labels; printed covert marks selectively applied to one or more portions of at least one of the first and second surfaces of the first and second labels; a protective coating selectively applied to the surface of the first and second labels containing the printed visible indicia first; and
a thermoplastic polymer for encapsulating the first and second labels during the in-mold process; and
a plurality of means for reading and processing the covert marking information represented on the plurality of in-mold chips.

20. An in-mold chip, formed in accordance with the method of claim 14.
